(19) United States
(12) Patent Application Publication
(10) Pub. No.: US 2015/0191112 A1
(43) Pub. Date: Jul. 9, 2015

(54) LID DEVICE AND SEAT DEVICE PROVIDED THEREWITH

(71) Applicant: TS TECH CO., LTD., ASAKA-SHI, SAITAMA (JP)

(72) Inventors: Yuji Kawashima, Shioya-Gun (JP); Takeshi Sato, Shioya-Gun (JP); Hideki Usami, Shioyo-Gun (JP); Hiroshi Izawa, Shioya-Gun (JP)

(73) Assignee: TS TECH CO., Ltd., Asaka-shi, Saitama (JP)

(21) Appl. No.: 14/416,455

(22) PCT Filed: Jul. 26, 2013
(86) PCT No.: PCT/JP2013/070313

§ 371 Date: Jan. 22, 2015

(30) Foreign Application Priority Data
Jul. 27, 2012 (JP) 2012-167046

(51) Int. Cl. B60N 2/64; A47C 7/62; A47C 7/40

(52) U.S. Cl. CPC B60N 2/64; A47C 7/40; A47C 7/62

(57) ABSTRACT

The present invention relates to a lid device and a seat device provided therewith. This lid device, which constitutes a seat device, comprises: a lid that is capable of closing an opening formed in a seat back; and an operation part that is slidably arranged in a recessed part formed in the lid. Guide rails are formed on the respective side surfaces of the recessed part. The operation part includes: slide parts that engage with the respective guide rails; and reception parts capable of contacting the bottom surface of the recessed part.

### TECHNICAL FIELD

The present invention relates to a lid device, which is capable of closing an opening formed in a seat back, as well as to a seat device provided with the same.

### BACKGROUND ART

Recently, a seat device equipped with a seat back, in which a trunk-through portion (opening) is formed that enables communication between a vehicle compartment and a trunk room, has been widely used. As one such type of seat back, there is known a seat back equipped with a lid device having a lid capable of closing the opening, a key cylinder retaining section disposed on the lid and which retains a key cylinder, and an operating unit that is disposed slidably in the key cylinder retaining section (see, for example, Japanese Laid-Open Patent Publication No. 08-216792).

### SUMMARY OF INVENTION

However, with the aforementioned conventional lid device, for example, in the case that a load of an occupant acts on the operating unit that makes up the lid device, since sliding members of the operating unit receive such a load, the sliding members become deformed. If this occurs, there is a concern that it may become impossible for the operating unit to slide smoothly, and that there is a concern that abnormal noise may be produced during sliding thereof.

The present invention has been devised with the aforementioned problems in mind, and has the object of providing a lid device as well as a seat device provided with such a lid device, which is capable of closing an opening formed in the seat back, which can suppress deformation of the sliding members, even in the event that loads are applied to the seat back, whereby it becomes possible for the operating unit to slide smoothly, and generation of noise can be suppressed.

The lid device according to the present invention has the following characterizing features:

First Feature: A lid device comprising a lid capable of closing an opening formed in a seat back, and an operating unit, which is disposed in a recess formed in the lid, in a condition of being slidable between a closed position of being engaged with a wall portion of the opening, and an open position of being disengaged from the wall portion. A guide section, which slidably guides the operating unit, is formed in a side surface constituting the recess. The operating unit includes a sliding member engaged with the guide section, and a receiving member, which is capable of contacting a bottom surface that is oriented toward a front side of the seat back among wall surfaces that constitute the recess.

Second Feature: The sliding member extends along a sliding direction of the operating unit, and the receiving member is disposed on both end portions of the sliding member.

Third Feature: The guide sections are formed respectively in facing relation to each other on the side surfaces that constitute the recess, and the receiving members are disposed respectively on a pair of the sliding members that engage with each of the guide sections in a state of being capable of contacting each of the side surfaces.

Fourth Feature: The receiving member is disposed across the entire length of the sliding member.

Fifth Feature: The receiving member is formed integrally with the sliding member, and in a state in which a load is not applied to the operating unit, the receiving member and the bottom surface are not in contact, whereas, in a state in which a load is applied to the operating unit, the receiving member and the bottom surface are in contact.

Sixth Feature: The operating unit includes an engagement pawl and a connecting member that connects the sliding members to each other. In a state of being positioned more rearwardly than the sliding members, the engagement pawl provided on the connecting member, and which engages with a wall portion of the opening. In addition, the receiving members are disposed on the engagement pawl, such that rear end surfaces of the receiving members are substantially flush with a rear end surface of the engagement pawl.

Seventh Feature: The receiving member is formed on the sliding member, and a sunken portion is formed at a location that makes up the receiving member, between a region in contact with the bottom surface and a region in contact with the guide section.

Eighth Feature: A rounded part having a predetermined radius of curvature is formed on a rear end portion of the receiving member, and a boundary region between the side surface and the bottom surface of the recess is formed in a shape corresponding to the rounded part so that the rounded part can be placed in surface contact therewith.

Ninth Feature: The receiving member includes a buffering member in contact with the bottom surface of the recess.

Tenth Feature: The operating unit includes a key cylinder arranged between the respective sliding members, an accommodating section in which the key cylinder is accommodated, and in which a cutout portion is formed that extends in an axial direction of the key cylinder, a spring member for retaining the key cylinder, a spring engaging member, which is formed by a part of a wall of the cutout portion projecting in a lateral direction of the cutout portion, and which is capable of engagement with the spring member, and a support member, which is contiguous with the sliding members and supports the accommodating section.

Eleventh Feature: A projecting amount by which the spring engaging member projects is greater than or equal to 0.5 times an opening width of the cutout portion.

A seat device according to the present invention comprises a seat cushion on which an occupant is seated, and a seat back connected to the seat cushion and in which an opening is formed, wherein the seat back includes a lid device according to any one of the aforementioned first through eleventh features.

In accordance with the first feature of the present invention, since the receiving member that constitutes the operating unit is capable of contacting a bottom surface that is oriented toward a front side of the seat back among wall surfaces that constitute the recess, for example, in the event that a load is applied to the front (operating unit) of the seat back, the load can be received by the receiving members. Consequently, since a load applied to the sliding members of the operating unit can be reduced, deformation of the sliding members can be suppressed. Thus, the operating unit can be made to slide smoothly, and the occurrence of noise during sliding can be suppressed.

According to the second feature of the present invention, since the receiving member is disposed on both end portions of the sliding members, loads applied to the sliding members can suitably be reduced.

According to the third feature of the present invention, the two guide sections are formed respectively on the opposite side surfaces that constitute the recess, and the receiving members are disposed respectively on a pair of the sliding members that engage with each of the guide sections, and therefore, the loads that act on the respective sliding members can be reduced. Further, when a load is applied to the operating unit, rattling of the operating unit can be suppressed. Moreover, since the respective receiving members are capable of contacting the respective side surfaces, rattling of the operating unit can further be suppressed.

According to the fourth feature of the present invention, since the receiving member is disposed across the entire length of the sliding member, a load applied to the sliding members can suitably be reduced, and rattling of the operating unit can suitably be suppressed.

According to the fifth feature of the present invention, since the receiving member is formed integrally with the sliding member, the rigidity of the receiving member can be increased. Further, since the receiving member and the bottom surface are not in contact in a state in which a load is not applied to the operating unit, ease of assembly of the operating unit in the recess can be enhanced.

According to the sixth feature of the present invention, since the receiving members are disposed on the engagement pawl, such that rear end surfaces of the receiving members are substantially flush with a rear end surface of the engagement pawl, the rigidity of the receiving members can further be increased.

According to the seventh feature of the present invention, since the sunken portion is formed at a location that makes up the receiving member, between a region in contact with the bottom surface of the recess within the operating unit and a region in contact with the guide section, a decrease in the rigidity of the receiving member can be suppressed, and the material cost of the operating unit can be reduced. Further, when a load is applied to the operating unit, the region that constitutes the sunken portion is flexible and can absorb such a load. Consequently, damage to the operating unit can suitably be suppressed.

According to the eighth feature of the present invention, because the boundary region between the side surface and the bottom surface that make up the recess is formed in a shape corresponding to the rounded part, such that the rounded part formed on rear end portion of the receiving member can be placed in surface contact therewith, a load can be received effectively by the receiving member.

According to the ninth feature of the present invention, since the receiving member includes the buffering member, a load applied to the operating unit can be absorbed by the buffering member. Further, when a load is applied to the operating unit, contact noise (abnormal noise) between the bottom surface and the receiving member can be suppressed.

According to the tenth feature of the present invention, since the accommodating section that houses the key cylinder is supported by the support member, which is contiguous with the respective sliding members on which the receiving members are provided, the rigidity of the accommodating section can be increased. Consequently, even in the case that the spring member, which retains the key cylinder, is latched on a spring engaging member constituted by a cutout portion of the accommodating section, when a load is applied to the operating unit, the spring member can be prevented from separating from the spring engaging member.

According to the eleventh feature of the present invention, a projecting amount of the spring engaging member is greater than or equal to 0.5 times the opening width of the cutout portion. Therefore, it is more difficult for the spring member to separate away from the projecting portion.

The seat device according to the present invention includes a lid device including any one of the first through eleventh features, and therefore, a seat device having the same advantages as those described above can be obtained.

### BRIEF DESCRIPTION OF DRAWINGS

FIG. 1 is a schematic perspective view of a seat device according to an embodiment of the present invention;

FIG. 2 is an outline perspective view of a lid device shown in FIG. 1;

FIG. 3 is a cross sectional view, with partial omission, taken along line III-III of FIG. 2;

FIG. 4 is a perspective view as seen from a front side of an operating unit constituting part of the lid device shown in FIG. 2;

FIG. 5 is a perspective view as seen from a rear side of the operating unit;

FIG. 6 is a cross sectional view taken along line VI-VI of FIG. 3;

FIG. 7 is a side view of the operating unit; and

FIG. 8 is a side view of an operating unit according to a modification of the present invention.

### DESCRIPTION OF EMBODIMENTS

Preferred embodiments of a lid device according to the present invention, and a seat device equipped with the lid device, will be described in detail below with reference to the accompanying drawings. In each of the drawings, as viewed in a direction of a seated passenger of the vehicle, the arrow “L” indicates a left side of the seat device, the arrow “R” indicates a right side of the seat device, the arrow “Fr” indicates a frontward direction of the seat device, and the arrow “Rr” indicates a rearward direction of the seat device.

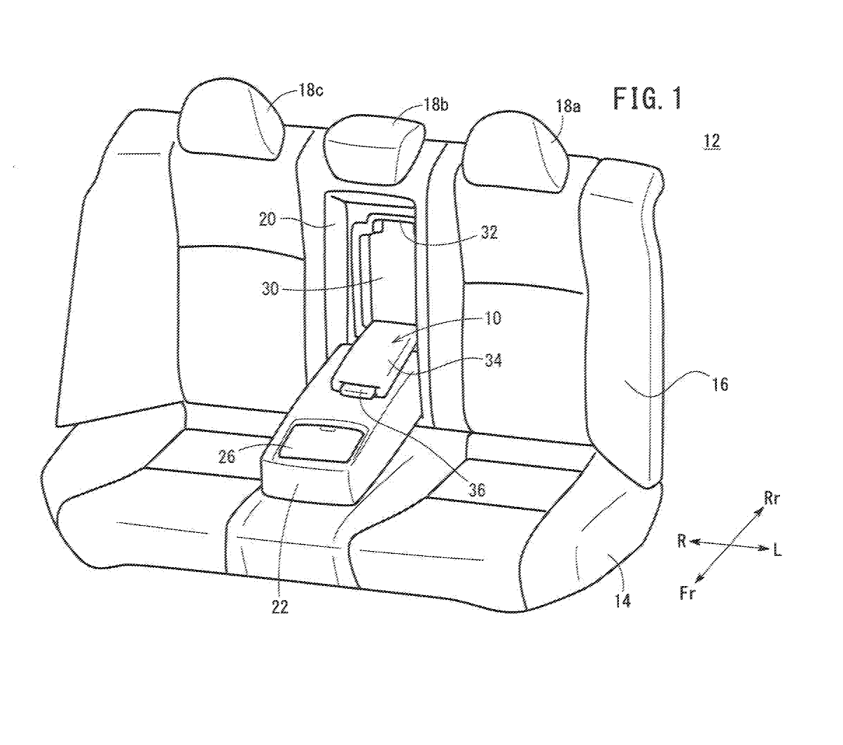

A seat device 12 according to the present invention is used as a rear seat of an automobile on which three persons can be seated. As shown in FIG. 1, the seat device 12 is equipped with a seat cushion 14 mounted in a non-illustrated vehicle body, and which supports the buttocks and thighs of the vehicle occupants, a seat back 16, which is supported tiltably on a rear end of the seat cushion 14 and serves to support the backs of the occupants, and three headrests 18a to 18c, which are vertically adjustable on an upper end of the seat back 16 and serve to support the heads of the occupants.

The seat back 16 includes an armrest 22 that is capable of being accommodated in a rectangular hole 20, which is formed substantially in a center portion in the widthwise direction (seat width direction, lateral direction), and a lid device 10, which is arranged to cover the hole 20 from a back surface side thereof. The armrest 22 is disposed rotatably with respect to a non-illustrated back frame that forms a skeleton of the seat back 16, and includes a cup holder 26.

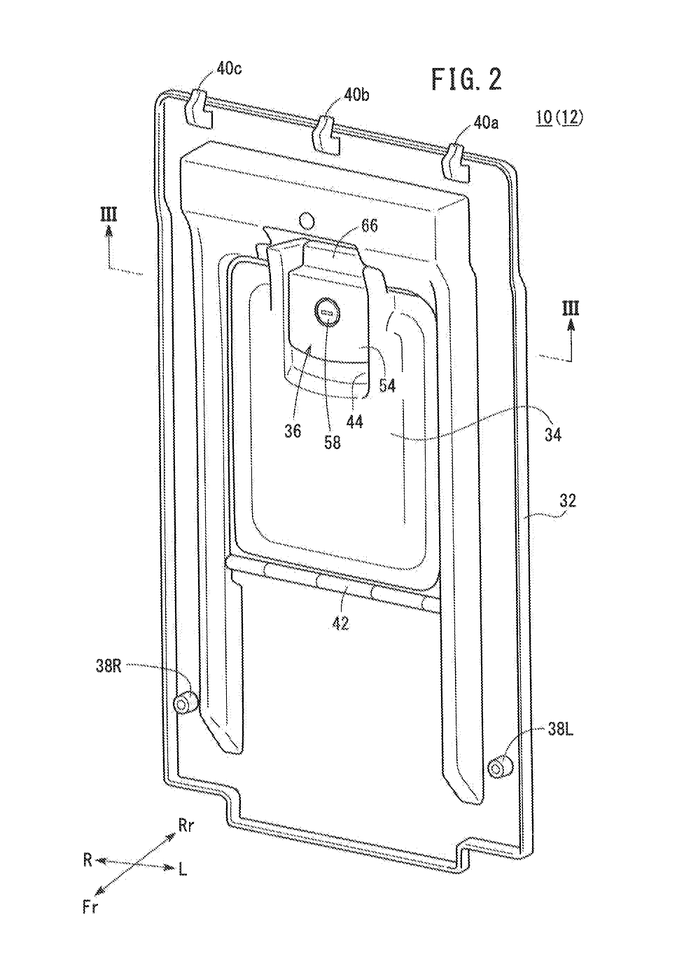

As shown in FIGS. 1 and 2, the lid device 10 is made from a resin material such as an ABS resin or the like, for example, and includes a lid frame 32, in which an opening (trunk-through portion) 30 is formed that establishes communication between a vehicle compartment and a trunk room in a state of being positioned on the back surface side of the armrest 22, a lid 34 capable of closing the opening 30, and an operating unit (slide knob) 36 for opening and closing the lid 34.

The lid frame 32 is a rectangular plate member that is slightly larger than the hole 20 and can be fixed to the back frame by a pair of left and right fixing members 38L, 38R arranged at lower portions on both sides, and a plurality (e.g., three) of fixing hooks 40a to 40c disposed on the upper end thereof. The opening 30 of the lid frame 32 is positioned somewhat higher than the center of the lid frame 32.

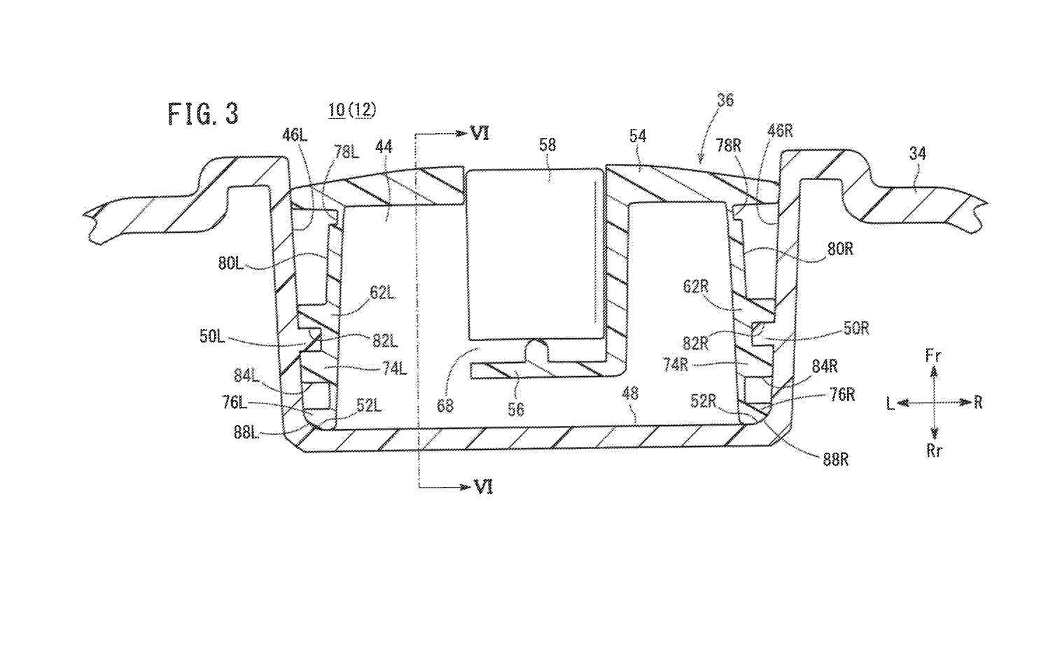

The lid 34 is disposed rotatably (tiltably) on the lid frame 32 through a hinge 42, which is disposed on a lower side wall that makes up the opening 30. As shown in FIG. 3, a recess 44, which is sunken into a back surface side, is formed on an upper front surface portion of the lid 34.

The recess 44 is substantially C-shaped (gate-shaped) in cross section, and includes a pair of left and right mutually facing side surfaces 46L, 46R, and a bottom surface 48, which is oriented toward a front side of the seat back 16 and connects the side surfaces 46L, 46R.

A pair of left and right guide rails (guide sections) 50L, 50R for slidably guiding the operating unit 36 are formed on the respective side surfaces 46L, 46R. The respective guide rails 50L, 50R extend along the heightwise direction of the seat back 16. Further, boundary regions 52L, 52R between the respective side surfaces 46L, 46R and the bottom surface 48 are formed with curved surfaces having a predetermined radius of curvature.

The operating unit 36 is arranged in the recess 44 in a slidable condition between a closed position of being engaged or latched on an upper side wall portion that makes up the opening 30 of the lid frame 32, and an open position of being disengaged from the upper side wall portion. The operating unit 36 is engaged with respect to the lid frame 32 in an upwardly biased state by a non-illustrated biasing member (spring member), which is interposed between the lid 34 and the operating unit 36.

As shown in FIGS. 3 through 7, the operating unit 36 includes a support wall (support member) 54 formed in a rectangular shape as viewed from the front, a bottomed cylinder-shaped accommodating section 56 that projects from a substantially center portion on a back surface side of the support wall 54, a key cylinder 58 arranged in the accommodating section 56, a spring member (clip) 60 for supporting the key cylinder 58 inside the accommodating section 56, a pair of left and right side walls 62L, 62R, which extend from opposite side portions of the support wall 54 toward a side where the accommodating section 56 is positioned, a connecting wall (connecting member) 64 that connects upper ends of the respective side walls 62L, 62R, and an engagement pawl 66 erected on the rear end of the connecting wall 64.

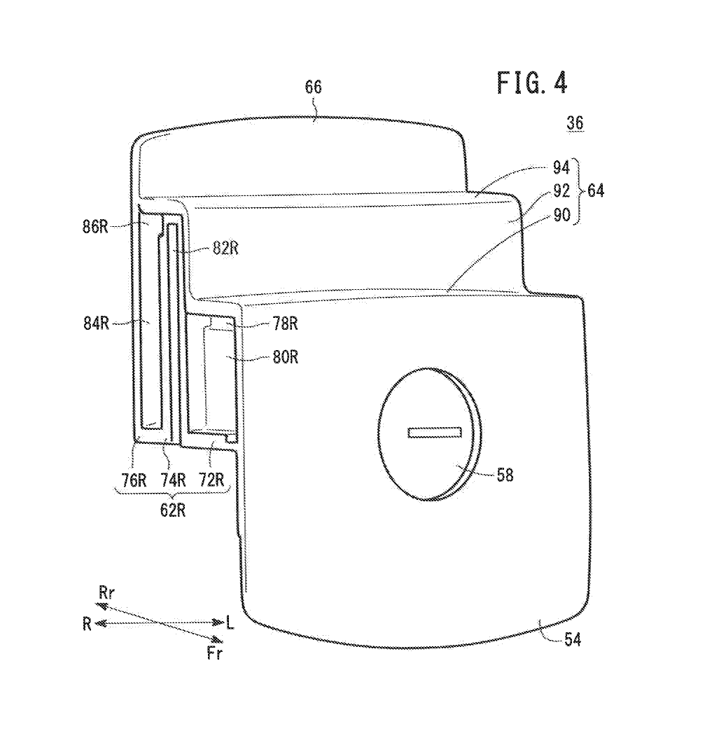

As can be understood from FIGS. 3 and 4, the inner hole of the accommodating section 56 opens substantially in the center on an outer surface of the support wall 54. In the accommodating section 56, a cutout portion 68 is formed along the forward/rearward direction (axial direction of the key cylinder 58), and a spring engaging member (projection) 70, which is formed by a portion of a wall constituting the cutout portion 68 projecting outwardly in a circumferential direction (lateral direction of the cutout portion 68) of the accommodating section 56.

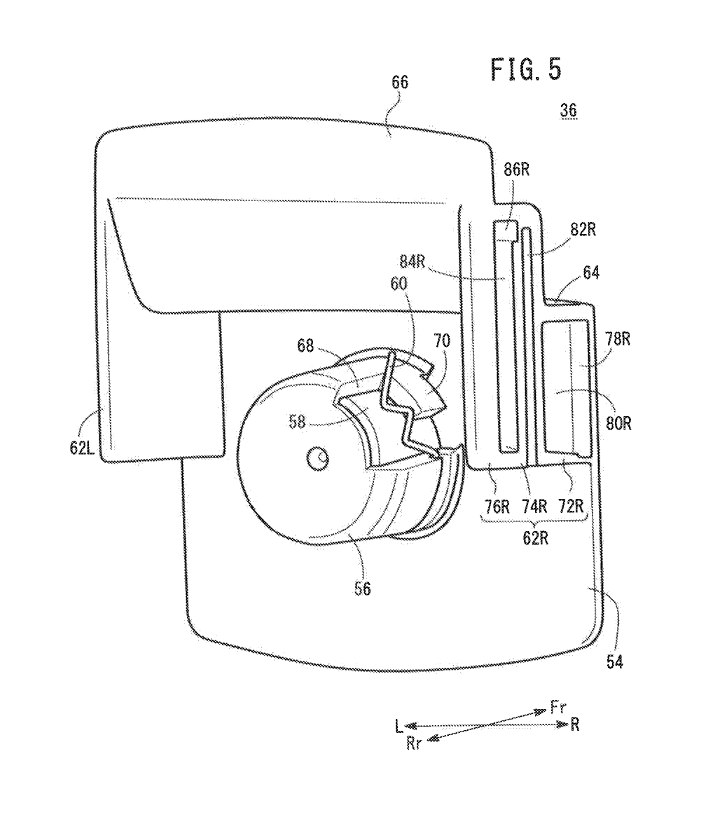

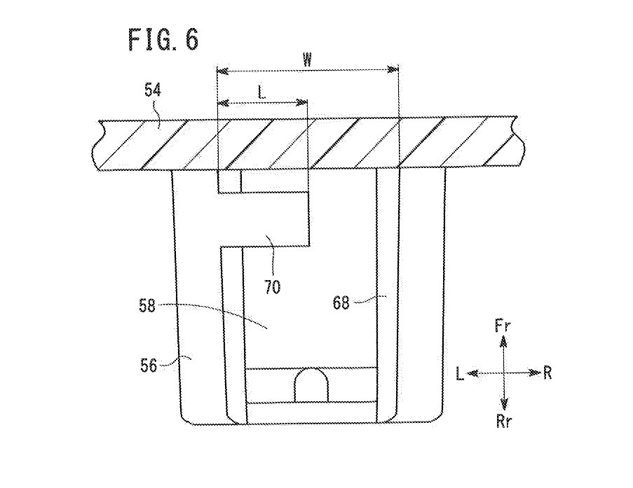

An end of the spring member 60 is latched over the spring engaging member 70 (see FIG. 5). Consequently, the key cylinder 58 can be retained in the interior of the accommodating section 56. Note that the spring member 60 is omitted from illustration in FIG. 6. A projecting amount L by which the spring engaging member 70 projects is equal to or greater than 0.5 times the opening width W (the width of the opening that is formed on the outer circumferential surface of the accommodating section 56) of the cutout portion 68 (see FIG. 6).

In this case, since a sufficient margin of engagement of the spring member 60 with respect to the spring engaging member 70 can be assured, for example, even in the case that an occupant leans on the armrest 22 that is accommodated in the hole 20, and loads are applied to the operating unit 36, the spring member 60 can be prevented from separating from the spring engaging member 70.

Although in FIG. 6 an example is shown in which the projecting length L of the spring engaging member 70 is on the order of 0.5 times the opening width W of the cutout portion 68, in the present embodiment, the projecting amount L of the spring engaging member 70 may be the same as the opening width W of the cutout portion 68. More specifically, in this case, since the spring engaging member 70 extends over the entire width of the cutout portion 68, separation of the spring member 60 from the spring engaging member 70 can be suppressed more effectively.

When locked by a non-illustrated key, the key cylinder 58 is locked in a state in which the operating unit 36 is in a closed state with respect to the lid 34. On the other hand, when the key cylinder 58 is unlocked by the key, the operating unit 36 can be placed in a slidable condition with respect to the lid 34.

The respective side walls 62L, 62R expand out in directions mutually away from each other as the side walls 62L, 62R become further distanced from the support wall 54 (see FIG. 3). The advantage attributable to this feature will be discussed later. Further, in a condition in which the operating unit 36 is arranged in the recess 44 of the lid 34, the respective side walls 62L, 62R are placed in facing relation to the respective side surfaces 46L, 46R that constitute the recess 44 (see FIG. 3).

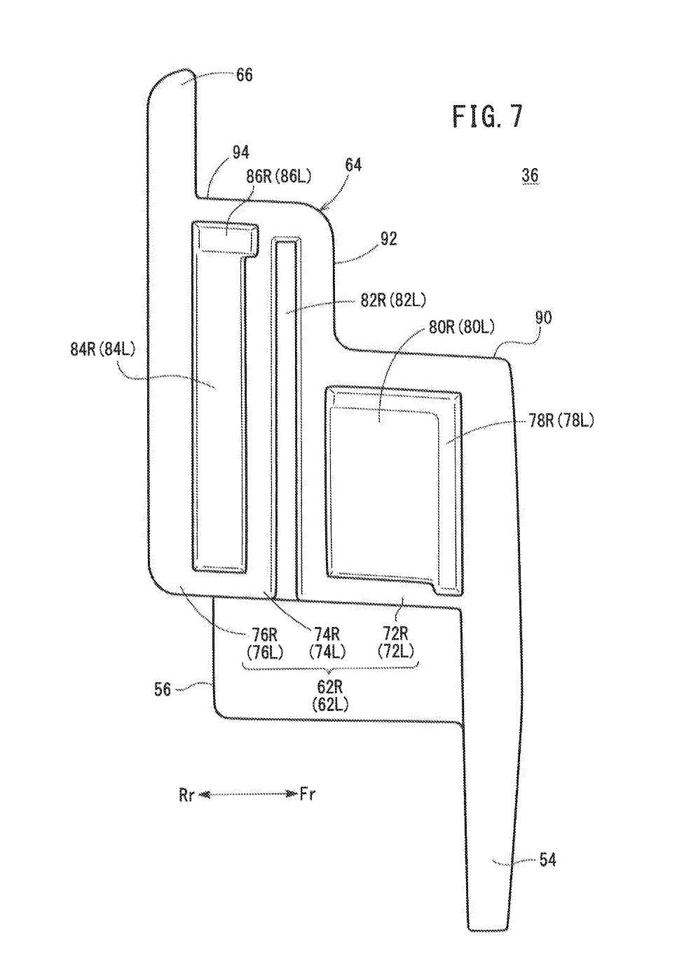

As shown in FIG. 7, each of the substantially L-shaped (as viewed from the side) side walls 62L, 62R includes extended portions 72L, 72R, which extend rearwardly from upper regions of the support wall 54, sliding members 74L, 74R, which extend upwardly contiguous with the rear ends of the extended portions 72L, 72R, and receiving members 76L, 76R, which extend in a rearward direction from rear ends of the sliding members 74L, 74R.

On outer surfaces of the extended portions 72L, 72R, first sunken portions 78L, 78R, which extend along the support wall 54 and are bent rearwardly at upper ends thereof, and second sunken portions 80L, 80R, which are rectangular shaped and connected to the first sunken portions 78L, 78R, are formed. The first sunken portions 78L, 78R are formed at a greater depth than the second sunken portions 80L, 80R (see FIG. 3).

On outer surfaces of the sliding members 74L, 74R, grooves 82L, 82R are formed that are engaged with the guide rails 50L, 50R. The grooves 82L, 82R extend from lower ends to an area in the vicinity of upper ends of the sliding members 74L, 74R. The receiving members 76L, 76R are formed integrally with the sliding members 74L, 74R, in a condition of being disposed across the entire length of the sliding members 74L, 74R. Owing thereto, the rigidity of the receiving members 76L, 76R can be increased.

The respective receiving members 76L, 76R are capable of contacting the respective side surfaces 46L, 46R constituting the recess 44. With the present embodiment, in a state in which loads are not applied to the operating unit 36, the respective receiving members 76L, 76R are placed in contact with each of the side surfaces 46L, 46R. In this case, rattling of the operating unit 36 can suitably be suppressed.

A structure may also be provided in which the respective receiving members 76L, 76R are kept out of contact with the respective side surfaces 46L, 46R in a state in which loads are not applied to the operating unit 36, but the respective receiving members 76L, 76R are placed in contact with the respective side surfaces 46L, 46R when loads are applied to the operating unit 36. In this case, rattling of the operating unit 36 can be suppressed when loads are applied to the operating unit 36, and ease in assembling the operating unit 36 in the recess 44 can be improved.

On outer surfaces of the receiving members 76L, 76R, third sunken portions 84L, 84R, which have a wide rectangular shape extending in a heightwise direction (the sliding direction of the operating unit 36), and fourth sunken portions 86L, 86R, which are rectangular and extend forwardly/rearwardly while being connected to the third sunken portions 84L, 84R, are formed. The fourth sunken portions 86L, 86R are formed at a greater depth than the third sunken portions 84L, 84R.

In the foregoing manner, since the third sunken portions 84L, 84R and the fourth sunken portions 86L, 86R are formed in the outer surfaces of the receiving members 76L, 76R, compared to a situation in which such sunken portions are not formed in the receiving members 76L, 76R, the rigidity of the receiving members 76L, 76R can be increased, and the material cost of the operating unit 36 can be reduced.

Further, by forming the third sunken portions 84L, 84R and the fourth sunken portions 86L, 86R in each of the receiving members 76L, 76R, if the operating unit 36 is made from a resin material, heat can be dissipated favorably from the receiving members 76L, 76R and the occurrence of shrinkage or sink marks thereon can be suppressed.

As can be understood from FIG. 3, in a condition in which the operating unit 36 is arranged in the recess 44 of the lid 34, the rear ends of the receiving members 76L, 76R are placed in contact with the bottom surface 48 of the recess 44. Further, rounded parts 88L, 88R having a predetermined radius of curvature are formed on rear end portions of the receiving members 76L, 76R. The shape of the rounded parts 88L, 88R corresponds to the shape of the boundary regions 52L, 52R between the side surfaces 46L, 46R and the bottom surface 48 that make up the recess 44.

The connecting wall 64 is formed in a stepped shape conforming to the shape of the upper portions of the side walls 62L, 62R. The connecting wall 64 includes a first connecting region 90 extending from an upper end of the support wall 54 to rear ends of the extended portions 72L, 72R, a second connecting region 92 erected from a rear end of the first connecting region 90, and a third connecting region 94 extending from an upper end of the second connecting region 92 to rear ends of the receiving members 76L, 76R.

The engagement pawl 66 is erected from the rear end of the third connecting region 94, and is capable of engaging with an upper side wall portion that constitutes the opening 30 within the lid frame 32. The rear end surface of the engagement pawl 66 lies substantially flush with the rear end surfaces of the receiving members 76L, 76R.

With a seat device 12 which is constructed in the foregoing manner, for example, in the case that the armrest 22 is accommodated in the hole 20, loads are applied to the operating unit 36 when an occupant leans against the armrest 22.

However, with the present embodiment, since the receiving members 76L, 76R that constitute the operating unit 36 are capable of contacting the bottom surface 48 that is oriented toward a front side of the seat back 16 among the wall surfaces that constitute the recess 44 in the lid 34, loads applied to the operating unit 36 can be received by the receiving members 76L, 76R. Consequently, since loads applied to the sliding members 74L, 74R of the operating unit 36 can be reduced, deformation of the sliding members 74L, 74R can be suppressed. Thus, the operating unit 36 can be made to slide smoothly, and the occurrence of noise during sliding can be suppressed.

Further, according to the present embodiment, since the receiving members 76L, 76R are disposed on both end portions (bottom end portion, top end portion) of the sliding members 74L, 74R, loads applied to the sliding members 74L, 74R can suitably be reduced.

Furthermore, since the pair of left and right side walls 62L, 62R of the operating unit 36 include the receiving members 76L, 76R, loads applied to the respective sliding members 74L, 74R can be reduced. Further, when loads are applied to the operating unit 36, rattling of the operating unit 36 can be suppressed.

According to the present embodiment, since the receiving members 76L, 76R are disposed across the entire length of the respective sliding members 74L, 74R, loads applied to the sliding members 74L, 74R can suitably be reduced, and rattling of the operating unit 36 can suitably be suppressed.

Further, the boundary regions 52L, 52R between the side surfaces 46L, 46R and the bottom surface 48 that make up the recess 44 are formed in a shape corresponding to the rounded parts 88L, 88R, and the rounded parts 88L, 88R that are formed on rear end portions of the receiving members 76L, 76R can be placed in surface contact with the boundary regions 52L, 52R. Thus, loads can be received effectively by the receiving members 76L, 76R.

According to the present embodiment, since the receiving members 76L, 76R are formed integrally with the sliding members 74L, 74R, the rigidity of the receiving members 76L, 76R can be increased. Furthermore, since the receiving members 76L, 76R are disposed on the engagement pawl 66, such that rear end surfaces of the receiving members 76L, 76R are substantially flush with a rear end surface of the engagement pawl 66, the rigidity of the receiving members 76L, 76R can further be increased. According to the present embodiment, since the third sunken portions 84L, 84R and the fourth sunken portions 86L, 86R are formed at locations that make up the receiving members 76L, 76R, between a region in contact with the bottom surface 48 of the recess 44 within the operating unit 36 and a region in contact with the guide rails 50L, 50R, a decrease in the rigidity of the receiving members 76L, 76R can be suppressed, and the material cost of the operating unit 36 can be reduced.

Furthermore, when loads are applied to the operating unit 36, the regions that constitute the third sunken portions 84L, 84R and the regions that constitute the fourth sunken portions 86L, 86R are elastically deformed and can absorb such loads. Consequently, damage to the operating unit 36 can suitably be suppressed.

According to the present embodiment, the accommodating section 56 in which the key cylinder 58 is accommodated is arranged between the pair of side walls 62L, 62R, and the accommodating section 56 is supported by the support wall 54 that is connected to each of the side walls 62L, 62R. Therefore, the rigidity of the accommodating section 56 can be increased. Consequently, even in the case that the spring member 60, which retains the key cylinder 58, is latched onto the spring engaging member 70 of the cutout portion 68 in the accommodating section 56, when loads are applied to the operating unit 36, the spring member 60 can be prevented from separating from the spring engaging member 70.

According to the present embodiment, the respective side walls 62L, 62R of the operating unit 36 expand outwardly in directions away from each other as the side walls 62L, 62R become further distanced from the support wall 54. Therefore, when loads applied to the operating unit 36 are received by the receiving members 76L, 76R, the operating unit 36 can be supported in a stable condition.

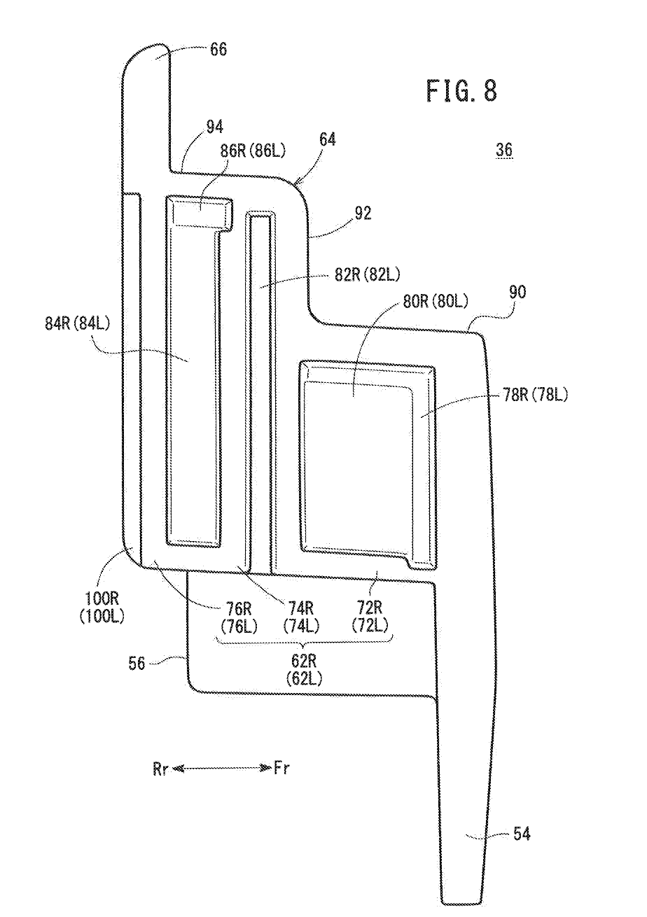

The present invention is not limited to the embodiment described above. For example, as shown in FIG. 8, the receiving members 76L, 76R of the respective side walls 62L, 62R may include buffering members 100L, 100R made of rubber or the like which contact the bottom surface 48 of the recess 44.

In this case, loads applied to the operating unit 36 can be absorbed by the buffering members 100L, 100R. Further, when loads are applied to the operating unit 36, contact noise (abnormal noise) between the bottom surface 48 and the receiving members 76L, 76R can be suppressed.

Further, in the present embodiment, the receiving members 76L, 76R that make up the respective side walls 62L, 62R may be connected directly to each other. In this case, since the contact area between the receiving members and the bottom surface 48 can be increased, loads applied to the operating unit 36 can be received more suitably by the receiving members 76L, 76R. Furthermore, with the present embodiment, either one of the pair of side walls 62L, 62R may be dispensed with.

In the lid device 10 according to the present embodiment, a structure may be adopted in which the receiving members 76L, 76R that make up the operating unit 36 are kept out of contact with the bottom surface 48 of the recess 44 in a state in which a load is not applied to the operating unit 36, but the respective receiving members 76L, 76R are placed in contact with the bottom surface 48 when loads are applied to the operating unit 36.

By such a feature, deformation of the sliding members 74L, 74R can be suppressed when loads are applied to the operating unit 36, and ease in assembling the operating unit 36 in the recess 44 can be improved. More specifically, upon assembly of the operating unit 36, since a gap is formed between the bottom surface 48 and the receiving members 76L, 76R, manufacturing variances of the lid 34 and the operating unit 36 can be absorbed.

The present invention is not limited to the embodiments described above, and various modified or alternative configurations may be adopted therein without departing from the essence of the present invention.

1. A lid device comprising:
a lid capable of closing an opening formed in a seat back; and
an operating unit, which is disposed in a recess formed in the lid, in a condition of being slidable between a closed position of being engaged with a wall portion of the opening, and an open position of being disengaged from the wall portion, wherein:
a guide section, which slidably guides the operating unit, is formed in a side surface constituting the recess; and
the operating unit having:
a sliding member engaged with the guide section; and
a receiving member, which is capable of contacting a bottom surface that is oriented toward a front side of the seat back among wall surfaces that constitute the recess.

2. The lid device according to claim 1, wherein:
the sliding member extends along a sliding direction of the operating unit; and
the receiving member is disposed on both end portions of the sliding member.

3. The lid device according to claim 2, wherein:
the guide sections are formed respectively in facing relation to each other on the side surfaces that constitute the recess; and
the receiving members are disposed respectively on a pair of the sliding members that engage with each of the guide sections in a state of being capable of contacting each of the side surfaces.

4. The lid device according to claim 2, wherein the receiving member is disposed across the entire length of the sliding member.

5. The lid device according to claim 2, wherein:
the receiving member is formed integrally with the sliding member; and
in a state in which a load is not applied to the operating unit, the receiving member and the bottom surface are not in contact, whereas, in a state in which a load is applied to the operating unit, the receiving member and the bottom surface are in contact.

6. The lid device according to claim 3, wherein:
the operating unit includes an engagement pawl and a connecting member that connects the sliding members to each other,
in a state of being positioned more rearwardly than the sliding members, the engagement pawl provided on the connecting member, and which engages with a wall portion of the opening; and
the receiving members are disposed on the engagement pawl, such that rear end surfaces of the receiving members are substantially flush with a rear end surface of the engagement pawl.

7. The lid device according to claim 1, wherein:
the receiving member is formed on the sliding member; and
a sunken portion is formed at a location of the operating unit that makes up the receiving member, between a region in contact with the bottom surface and a region in contact with the guide section.

8. The lid device according to claim 2, wherein:
a rounded part having a predetermined radius of curvature is formed on a rear end portion of the receiving member; and
a boundary region between the side surface and the bottom surface of the recess is formed in a shape corresponding to the rounded part so that the rounded part can be placed in surface contact therewith.

9. The lid device according to claim 1, wherein the receiving member includes a buffering member in contact with the bottom surface of the recess.

10. The lid device according to claim 3, wherein the operating unit comprises:
a key cylinder arranged between the respective sliding members;
an accommodating section in which the key cylinder is accommodated, and in which a cutout portion is formed that extends in an axial direction of the key cylinder;
a spring member for retaining the key cylinder;
a spring engaging member, which is formed by a part of a wall of the cutout portion projecting in a lateral direction of the cutout portion, and which is capable of engagement with the spring member; and
a support member, which is contiguous with the sliding members and supports the accommodating section.

11. The lid device according to claim 10, wherein a projecting amount by which the spring engaging member projects is greater than or equal to 0.5 times an opening width of the cutout portion.

12. A seat device comprising:
a seat cushion on which an occupant is seated; and
a seat back connected to the seat cushion and in which an opening is formed,
wherein the seat back includes a lid device comprising:
a lid capable of closing the opening formed in the seat back; and
an operating unit, which is disposed in a recess formed in the lid, in a condition of being slidable between a closed position of being engaged with wall portion of the opening, and an open position of being disengaged from the wall portion, wherein:
a guide section, which slidably guides the operating unit, is formed in a side surface constituting the recess; and
the operating unit having:
a sliding member engaged with the guide section; and
a receiving member, which is capable of contacting a bottom surface that is oriented toward a front side of the seat back among wall surfaces that constitute the recess.
